(19) United States
(12) Patent Application Publication
(10) Pub. No.: US 2007/0232773 A1
(43) Pub. Date: Oct. 4, 2007

(54) Polyester polyol and process for producing the same

(75) Inventors: Toshio Endo, Hiroshima (JP); Hidetoshi Omori, Hiroshima (JP); Tatsumi Fujii, Hiroshima (JP)

Correspondence Address: BIRCH STEWART KOLASCH & BIRCH, PO BOX 747, FALLS CHURCH, VA, 22040-0747, US

(73) Assignee: Daicel Chemical Industries, Ltd.

(21) Appl. No.: 11/727,098

(22) Filed: Mar. 23, 2007

(30) Foreign Application Priority Data
Mar. 28, 2006 (JP) 089415/2006

(51) Int. Cl. C08G 18/00; C08G 63/82

(52) U.S. Cl. 528/44; 528/355

(57) ABSTRACT

A cyclic ester (e.g., a lactone such as ε-caprolactone) is ring-opening addition polymerized with a dihydroxycarboxylic acid in the presence of a basic compound (e.g., an amine). In a polyester polyol obtained by such a process, at least part of a carboxyl group of the polyester polyol forms a carboxylate with the basic compound, and the content of the dihydroxycarboxylic acid in a free form can be remarkably reduced (for example, reduced to not more than 5% by weight relative to the total polyester polyol). According to the present invention, a polyester polyol having a reduced content of a free or unreacted dihydroxycarboxylic acid is provided even in the case of using a dihydroxycarboxylic acid (e.g., a dimethylolalkanoic acid such as dimethylolpropionic acid) as an initiator.

### FIELD OF THE INVENTION

The present invention relates to a carboxyl group-containing polyester polyol which is useful as a polyol component for producing a polyurethane-series resin (particularly, an aqueous polyurethane-series resin) or others, and a process for producing the same.

### BACKGROUND OF THE INVENTION

Conventionally, among polyurethane-series resins, an aqueous polyurethane-series resin has been utilized for a paint, a binder, an adhesive and others due to excellent flexibility, mechanical properties, adhesiveness and others. Recently, the movement for the environmental improvement such as the restriction on atmospheric discharge of organic solvents has increasingly promoted the development and utilization of the aqueous polyurethane-series resin.

In order to obtain such an aqueous polyurethane-series resin, many attempts for having a polyurethane-series resin aqueous by introducing a hydrophilic group to the molecular chain of the polyurethane-series resin have been conducted. Among others, an anionic polyurethane-series resin having a carboxylate salt group (a carboxyl group neutralized with a basic substance) introduced to the molecular chain (polyurethane chain) thereof has been actively examined since the resin is excellent in water resistance. As a process for producing such an anionic polyurethane-series resin, for example, Japanese Patent Publication No. 5485/1986 (JP-61-5485B (Claims and Examples)), Japanese Patent Publication No. 48955/1991 (JP-3-48955B (Claims and Examples)), Japanese Patent Publication No. 488/1992 (JP-4-488B (Claims and Examples)) and others disclose a process which comprises reacting a polyisocyanate-series compound, a polyol-series compound and a carboxyl group-containing diol (such as 2,2-dimethylolpropionic acid) to give a urethane prepolymer having an isocyanate group (NCO group) in an end thereof (a urethane prepolymer having an end NCO group), neutralizing a carboxyl group in the molecule of thus obtained urethane prepolymer having an end NCO group with a basic substance to disperse or dissolve the prepolymer in water, and chain-extending the prepolymer with a polyamine-series compound to give an anionic polyurethane-series resin.

However, in the processes described in these documents, on the occasion of obtaining a urethane prepolymer, since 2,2-dimethylolpropionic acid used as a carboxyl group-containing diol has a poor solubility in a polyisocyanate-series compound or a polyol-series compound, and additionally in a generally used organic solvent having a low boiling point (for example, acetone, and methyl ethyl ketone), the reaction system becomes heterogeneous in the absence of a solvent or in such an organic solvent having a low boiling point so that a gel product tends to be generated. Therefore, in order to carry out the prepolymerization reaction in a homogeneous system, it has been substantially necessary to use an organic solvent having a high boiling point (such as dimethylformamide or N-methylpyrrolidone) as a solvent for sufficiently dissolving 2,2-dimethylolpropionic acid or others. In addition, since it is difficult to remove such an organic solvent having a high boiling point from the reaction system after making the polyurethane-series resin aqueous, the organic solvent finally remains in the solution of the aqueous polyurethane-series resin (composition). Accordingly, on the occasion of coating or applying the obtained aqueous polyurethane-series resin composition, the dryness of the coating film or the working environment is deteriorated.

Therefore, attempts for allowing a polyol to react with a carboxyl group-containing diol (for example, a dimethylolalkanoic acid such as 2,2-dimethylolpropionic acid) to introduce a carboxyl group beforehand to the polyol have been also conducted. As such a polyol compound having a carboxyl group introduced thereto, for example, Japanese Patent Application Laid-Open No. 313024/1994 (JP-6-313024A (Claims)) discloses an aqueous polyurethane resin comprising a neutralized product of a polyurethane resin having an acid value of not less than 10 in a concentration of a carboxyl group with any one of an ammonia, an inorganic base and an amine, wherein the aqueous polyurethane resin is obtained by (A) a lactone-series polyester polyol obtained by a ring-opening addition polymerization of a lactone (e.g., ε-caprolactone) with a dihydroxycarboxylic acid (e.g., 2,2-dimethylolpropionic acid) as an initiator, (B) an organic diisocyanate and (C) a chain-elongation agent. Moreover, Japanese Patent Application Laid-Open No. 27243/1996 (JP-8-27243A (Claims)) discloses an aqueous polyurethane resin containing a carboxyl group neutralized with a basic substance in the molecular chain of the resin, and discloses that the aqueous polyurethane resin is obtained by allowing a polyisocyanate compound to react with a carboxyl group-containing polyester polyol having a number average molecular weight of 250 to 5000 which is obtained by a ring-opening polymerization of ε-caprolactone with a dimethylolalkanoic acid (e.g., dimethylolpropionic acid). Further, Japanese Patent Application Laid-Open No. 91740/2004 (JP-2004-91740A (Claims)) discloses a carboxyl group-containing polyester polyol obtained by a ring-opening polymerization of ε-caprolactone with a compound represented by the formula (1): HOCH₂C(COOH)RCH₂OH (1) (in the formula, R represents an alkyl group having not less than C₂) (e.g., dimethylolbutanoic acid), wherein the polyester polyol has a number average molecular weight of 550 to 950 and is in the form of a liquid at a room temperature.

However, in the carboxyl group-containing polyester polyols described in these documents, a large amount of a carboxyl group-containing diol (e.g., a dimethylolalkanoic acid) to which the lactone (e.g., ε-caprolactone) or a ring-opened product thereof is not added (that is, an unreacted or free carboxyl group-containing diol) remains. Such a carboxyl group-containing diol (particularly, a dihydroxycarboxylic acid such as dimethylolalkanoic acid) is usually poor in solubility, and is easy to be crystallized alone in the polyester polyol. Therefore, the fact has been that a polyester polyol used in producing a polyurethane-series resin contains a carboxyl group-containing diol in the state of phase separation caused by crystallization.

In order to apply such a carboxyl group-containing polyester polyol for industrial use, it is necessary to dissolve the phase-separated carboxyl group-containing diol (particularly, a dimethylolalkanoic acid). The method for dissolving the carboxyl group-containing diol may include, for example, a method of adding a solvent having a high boiling point as mentioned above, a method of heating the polyester polyol, and others. However, each method is remarkably disadvantageous from industrial point of view since the process is complicated. That is, in the former method, as the same as described above, on the occasion of forming the aqueous polyurethane-series resin, the dryness of the coating film or the workability is remarkably deteriorated. In the latter method, it is necessary to heat the carboxyl group-containing diol at a high temperature again for dissolution, and therefore the method has a large industrial loss. In particular, among dimethylolalkanoic acids, 2,2-dimethylolpropionic acid is further industrially disadvantageous for dissolution because of the high melting point. Moreover, in the case of using 2,2-dimethylolbutanoic acid and others, a carboxyl group-containing polyester polyol in the form of a liquid at a room temperature can be obtained immediately after polymerization. However, when the polyester polyol is stored (particularly, stored under a low temperature) over the long term, 2,2-dimethylolbutanoic acid or others is still crystallized to generate phase separation, in the same manner as 2,2-dimethylolpropionic acid.

Therefore, a carboxyl group-containing polyester polyol having a reduced content of a free carboxyl group-containing diol has been required.

### SUMMARY OF THE INVENTION

It is therefore an object of the present invention to provide a carboxyl group-containing polyester polyol in which the content of a free (or unreacted) dihydroxycarboxylic acid is small even in the case of using a dihydroxycarboxylic acid as an initiator, and a process for producing the same.

Another object of the present invention is to provide a carboxyl group-containing polyester polyol excellent in homogeneity (or uniformity) and solubility even in the case of using a dihydroxycarboxylic acid as an initiator, and a process for producing the same.

It is still another object of the present invention to provide a carboxyl group-containing polyester polyol having a reduced content of a free dihydroxycarboxylic acid, being capable of controlling a carboxyl group concentration to a desired concentration, and being excellent in handling properties; and a process for producing the same.

It is a further object of the present invention to provide a carboxyl group-containing polyester polyol which is excellent in homogeneity (or uniformity) and stability and improves in dryness or working environment in coating, and a process for producing the same.

It is a still further object of the present invention to provide a carboxyl group-containing polyester polyol which can be subjected advantageously from industrial point of view to a urethanation in a homogeneous (or uniform) system with a polyisocyanate without adding a solvent having a high boiling point or heating the reaction system again, and a process for producing the same.

It is another object of the present invention to provide a process for producing a carboxyl group-containing polyester polyol in which the content of a free dihydroxycarboxylic acid can be efficiently reduced.

The inventors of the present invention made intensive studies to achieve the above objects and finally found as follows: in a carboxyl group-containing polyester polyol obtainable by a ring-opening addition polymerization of a cyclic ester (particularly, a lactone such as caprolactone) with a dihydroxycarboxylic acid as a initiator, the polyester polyol at least has a carboxyl group neutralized with a basic compound and has a remarkably lower content of a free dihydroxycarboxylic acid compared with a polyester polyol free from a neutralized carboxyl group; particularly, a dihycroxycarboxylic acid having a carboxyl group neutralized with a basic compound (e.g., a tertiary amine) may be used as the initiator; and further the urethanation of the carboxyl group-containing polyester polyol as a polyol component ensures to obtain a urethane prepolymer (a polyurethane-series resin) which is excellent in dryness or working environment in coating and has a high homogeneity and an excellent stability. The present invention has been accomplished based on the above findings.

That is, the polyester polyol of the present invention is a polyester polyol in which a cyclic ester is ring-opening addition polymerized with a dihydroxycarboxylic acid as an initiator, wherein at least part of a carboxyl group of the polyester polyol forms a carboxylate with a basic compound.

The dihydroxycarboxylic acid may comprise a dihydroxyalkanoic acid (for example, a dimethylolalkanoic acid). Moreover, the cyclic ester may comprise a lactone [for example, a C₄₋₁₀lactone such as a caprolactone (e.g., ε-caprolactone, and a methyl-ε-caprolactone)]. The basic compound may comprise an amine. In particular, the basic compound may comprise a tertiary amine.

The number average molecular weight of the polyester polyol of the present invention may be, for example, about 250 to 10000.

In the polyester polyol of the present invention, a free or unreacted dihydroxycarboxylic acid content is reduced in spite of using the dihydroxycarboxylic acid as an initiator. For example, the dihydroxycarboxylic acid in a free form may be present in a proportion of not more than 5% by weight relative to the total polyester polyol.

The representative polyester polyol of the present invention may include the polyester polyol in which (i) the dihydroxycarboxylic acid comprises a 2,2-dimethylol-C₃₋₆monoalkanecarboxylic acid, (ii) the cyclic ester comprises a C₄₋₁₀lactone, (iii) the basic compound comprises at least one member selected from the group consisting of a tertiary alkylamine, a tertiary cycloalkylamine and a tertiary alkanolamine, (iv) the number average molecular weight of the polyester polyol is 300 to 5000, and (v) the dihydroxycarboxylic acid in a free form is present in a proportion of not more than 3% by weight relative to the total polyester polyol; and others.

The polyester polyol of the present invention may be utilized for a polyol component as a polymerization component of a variety of polymers. In particular, the polyester polyol may constitute a polyol component of a polyurethane-series resin.

The polyester polyol of the present invention may be usually produced by ring-opening addition polymerizing a cyclic ester with a dihydroxycarboxylic acid in the presence of a basic compound. In particular, in the production process, the cyclic ester may be ring-opening addition polymerized with a salt of the dihydroxycarboxylic acid and the basic compound. By the ring-opening addition polymerization in such a process, a content of an unreacted dihydroxycarboxylic acid (free dihydroxycarboxylic acid) remaining in the polyester polyol can be reduced at a high level.

The present invention also includes a polyurethane-series resin comprising at least the following components: a polyol component comprising the polyester polyol and a polyisocyanate component.

### DETAILED DESCRIPTION OF THE INVENTION

### [Polyester Polyol]

The polyester polyol of the present invention (a carboxyl group-containing polyester polyol, an amine carboxylate group-containing polyester polyol) is a polyester polyol in which a cyclic ester is ring-opening addition polymerized with a dihydroxycarboxylic acid as an initiator. In the polyester polyol, at least part of a carboxyl group of the polyester polyol forms a carboxylate with a basic compound. That is, in the polyester polyol of the present invention, at least part of the carboxyl group of the dihydroxycarboxylic acid is neutralized. Incidentally, throughout this specification, the term “polyester polyol” sometimes means not only a polyester polyol in which a cyclic ester is added to a dihydroxycarboxylic acid but also a composition containing a free dihydroxycarboxylic acid and basic compound or others (a polyester polyol composition, a product of a ring-opening addition polymerization).

### (Dihydroxycarboxylic Acid)

The dihydroxycarboxylic acid used for producing the carboxyl group-containing polyester polyol is not particularly limited to a specific one as far as the carboxylic acid has two hydroxyl groups. In particular, the hydroxyl group may be a hydroxyl group constituting a methylol group (hydroxymethyl group). The hydroxyl group (particularly, methylol group) may be bonded to a carbon atom of a carboxylic acid (e.g., an alkanoic acid) (except a carbon atom of a carboxyl group). It is sufficient that the two hydroxyl groups (particularly, methylol groups) may be bonded to the same or different carbon atom. The two hydroxyl groups are preferably bonded to the same carbon atom, and particularly preferably bonded to a carbon atom in 2-position of the carboxylic acid (or a carbon atom in α-position thereof).

In the dihydroxycarboxylic acid, the corresponding carboxylic acid may be a carboxylic acid such as an aliphatic carboxylic acid, an alicyclic carboxylic acid or an aromatic carboxylic acid, and may be usually an aliphatic carboxylic acid (particularly, a saturated carboxylic acid such as an alkanoic acid). Moreover, the carboxylic acid may be a monocarboxylic acid or a polycarboxylic acid (for example, a di- to tetracarboxylic acid such as an alkanedioic acid), and may be particularly a monocarboxylic acid (for example, an alkanemonocarboxylic acid).

The representative dihydroxycarboxylic acid may include, for example, a dihydroxyalkanoic acid (for example, a dihydroxyC₃₋₂₀alkanemono- or dicarboxylic acid such as 2,2-dimethylolpropionic acid (2,2-di(hydroxymethyl)propionic acid), 2,2-dimethylolbutanoic acid (2,2-di(hydroxymethyl)butanoic acid), 2,2-dimethylolpentanoic acid, 2,2-dimethylolhexanoic acid, 2,2-dimethylolheptanoic acid, 2,2-dimethyloloctanoic acid, tartaric acid or dihydroxyadipic acid, preferably a dihydroxyC₄₋₁₄alkanemonocarboxylic acid).

The preferred dihydroxycarboxylic acid includes a dimethylolalkanoic acid (for example, a dimethylolC₂₋₁₀mono- or dialkanecarboxylic acid, preferably a dimethylolC₃₋₈mono- or dialkanecarboxylic acid). In particular, a 2,2-dimethylolmonoalkanecarboxylic acid (for example, a 2,2-dimethylolC₂₋₁₀monoalkanecarboxylic acid such as 2,2-dimethylolpropionic acid or 2,2-dimethylolbutanoic acid, preferably a 2,2-dimethylolC₂₋₈monoalkanecarboxylic acid, more preferably a 2,2-dimethylolC₃₋₆monoalkanecarboxylic acid, and particularly a 2,2-dimethylolC₃₋₄monoalkanecarboxylic acid) is preferred.

In the present invention, among these 2,2-dimethylolalkanoic acids, 2,2-dimethylolpropionic acid, 2,2-dimethylolbutanoic acid or 2,2-dimethylolpentanoic acid is preferred, and 2,2-dimethylolpropionic acid or 2,2-dimethylolbutanoic acid is more preferred. In particular, 2,2-dimethylolpropionic acid is preferably usable.

The dihydroxycarboxylic acids may be used singly or in combination.

### (Cyclic Ester)

The cyclic ester is not particularly limited to a specific one as far as the cyclic ester is a cyclic compound having at least one ester group (—COO—) in a molecule thereof. For example, the cyclic ester may include a lactone, a cyclic diester (e.g., a C₄₋₁₅cyclic diester such as a glycolide or a lactide (L-lactide, D-lactide, or a mixture thereof), preferably a C₄₋₁₀cyclic diester), and others. The cyclic esters may be used singly or in combination.

The cyclic ester may usually comprise a lactone. The lactone (or cyclic monoester) may include, for example, a C₃₋₂₀lactone such as β-propiolactone, β-butyrolactone, γ-butyrolactone, δ-valerolactone, δ-caprolactone, ε-caprolactone, γ-valerolactone, γ-caprolactone, γ-caprirolactone, γ-laurolactone, enantholactone, dodecanolactone, stearolactone or an alkyl-ε-caprolactone [for example, a methyl-ε-caprolactone such as a monomethyl-ε-caprolactone (e.g., α-methyl-ε-caprolactone, β-methyl-ε-caprolactone, and γ-methyl-ε-caprolactone), a dimethyl-ε-caprolactone (e.g., β,δ-dimethyl-ε-caprolactone) or a trimethyl-ε-caprolactone (e.g., 3,3,5-trimethyl-ε-caprolactone)] (preferably a C₄₋₁₅lactone, and more preferably a C₄₋₁₀lactone). The lactones may be used singly or in combination.

The particularly preferred cyclic ester (the lactone) includes an ε-caprolactone compound (e.g., ε-caprolactone, and an ε-caprolactone derivative such as a methyl-ε-caprolactone, particularly, ε-caprolactone) from the viewpoint that such a compound is polymerizable under a mild condition or is easily obtainable and industrially low-cost.

### (Basic Compound)

The basic compound may be an inorganic basic compound [for example, a metal hydroxide (e.g., an alkali or alkaline earth metal hydroxide), a metal carbonate (e.g., an alkali or alkaline earth metal carbonate), a metal hydrogen carbonate (e. g., an alkali or alkaline earth metal hydrogen carbonate), and ammonia], and may usually comprise at least a basic organic compound.

As the basic organic compound, there may be mentioned a carboxylate salt (for example, an alkanoate salt such as a metal acetate salt), an amine, and others. The amine may be preferably used.

The amine may be a monoamine or a polyamine (e.g., a diamine, and a triamine). Moreover, the amine may be a chain amine or a cyclic amine, or may be an aliphatic amine or an aromatic amine. Further, the amine may be an amine having a hetero atom other than a nitrogen atom (e.g., an oxygen atom) in a molecule thereof (for example, a heterocyclic amine). Incidentally, the amine may have a substituent (for example, a functional group such as a hydroxyl group or a halogen atom). The amine may be any one of a primary amine, a secondary amine and a tertiary amine. The amine is preferably a secondary amine or a tertiary amine, and is particularly preferably a tertiary amine. Moreover, as the basic organic compound, a compound which does not initiate a ring-opening addition polymerization of a cyclic ester on its own (for example, a compound having no active hydrogen atom, such as a tertiary amine) may be preferably used.

The representative amine may include an alkylamine (for example, a C₁₋₁₈alkylamine such as trimethylamine, methyldiethylamine, triethylamine, tripropylamine, triisopropylamine, triisooctylamine or diethylamine, preferably a C₁₋₁₀alkylamine, and more preferably a C₁₋₆alkylamine), a cycloalkylamine (for example, a C₄₋₁₀cycloalkylamine such as tricyclohexylamine, and preferably a C₅₋₈cycloalkylamine), an arylamine (for example, a C₆₋₁₀arylamine such as triphenylamine, and preferably a C₆₋₈arylamine), a hydroxyamine [for example, a hydroxyC₁₋₁₈alkylamine such as ethanolamine, dimethylethanolamine, methyldiethanolamine or triethanolamine, preferably a hydroxyC₁₋₁₀alkylamine, and more preferably a hydroxyC₁₋₆alkylamine], a cyclic amine (for example, a heterocyclic amine such as N-methylpiperidine or morpholine), and others. The amines may be used singly or in combination.

Among these amines, the preferred one includes a tertiary amine such as a tertiary alkylamine [for example, a trialkylamine (e.g., a triC₁₋₁₀alkylamine such as trimethylamine, triethylamine or triisooctylamine)], a tertiary cycloalkylamine [for example, a tricycloalkylamine (e.g., a triC₅₋₈cycloalkylamine such as tricyclohexylamine)] or a tertiary alkanolamine [for example, a dialkylmono(hydroxyalkyl)amine (e.g., a diC₁₄alkylmono(hydroxyC₂₋₄alkyl)amine such as dimethylethanolamine), an alkyldi(hydroxyalkyl)amine t(e.g., a C₁₋₄alkyldi(hydroxyC₂₋₄alkyl)amine such as methyldiethanolamine), and a tri(hydroxyalkyl) amine (e.g., a tri(hydroxyC₂₋₄alkyl)amine such as triethanolamine)].

The number average molecular weight of the polyester polyol of the present invention may be, for example, about 250 to 10000, preferably about 300 to 5000, more preferably about 350 to 2000, and particularly about 400 to 1500. In the case where the number average molecular weight is too small (e.g., smaller than 250), the amine carboxylate group-containing polyester polyol does not exist, but an amine salt of a dimethylolalkanoic acid exists alone in many cases. On the other hand, in the case where the number average molecular weight of the amine carboxylate group-containing polyester polyol is too large (e.g., over 10000), the concentration of the amine carboxylate contained in a molecular chain thereof is too low (for example, not higher than 0.5%). As a result, there is a possibility that the polyurethane-series resin is insufficiently aqueous.

Incidentally, the polyester polyol of the present invention may be usually in the form of a liquid at a room temperature or ordinary temperature (e. g., about 15 to 25° C.).

Moreover, the acid value of the polyester polyol of the present invention may be, for example, not less than 10 KOHmg/g (e.g., about 10 to 350 KOHmg/g), preferably about 20 to 300 KOHmg/g, more preferably about 25 to 250 KOHmg/g, particularly about 30 to 200 KOHmg/g, and usually about 35 to 100 KOHmg/g (e.g., about 40 to 80 KOHmg/g).

In the polyester polyol of the present invention, it is sufficient that at least part of the carboxyl group may be neutralized. The proportion of the basic compound relative to 1 equivalent the carboxyl group of the polyester polyol (the carboxyl group of the polyester polyol and the free dihydroxycarboxylic acid) may be, for example, about 0.5 to 2 equivalents, preferably about 0.6 to 1.8 equivalents, more preferably about 0.7 to 1.5 equivalents and particularly about 0.8 to 1.2 equivalents, and may be usually about 0.5 to 1 equivalent.

In the polyester polyol of the present invention, as mentioned above, the content of the free (or unreacted) dihydroxycarboxylic acid is remarkably low in spite of using the dihydroxycarboxylic acid as an initiator. For example, in the polyester polyol of the present invention, the proportion of the free dihydroxycarboxylic acid relative to the total polyester polyol is not more than 7% by weight (e.g., 0 or detection limit to 6% by weight), preferably not more than 5% by weight (e.g., about 0.1 to 4.5% by weight), more preferably not more than 4% by weight (e.g., about 0.3 to 3.5% by weight), and particularly not more than 3% by weight (e.g., about 0.5 to 2.5% by weight).

As described above, since the content of the free dihydroxycarboxylic acid is reduced in the polyester polyol of the present invention, the polyester polyol is excellent in solubility and is high in homogeneity and stability compared with a conventional carboxyl group-containing polyester polyol (for example, a carboxyl group-containing polyester polyol in which the content of the dihydroxycarboxylic acid is not reduced and the amount of the dihydroxycarboxylic acid is over 7% by weight relative to the total amount of the free dihydroxycarboxylic acid, the cyclic ester and the carboxyl group- containing polyester polyol).

Therefore, even in the case of using the polyester polyol of the present invention as a polyol in preparing a urethane prepolymer, it is unnecessary to use a solvent having a high boiling point [for example, a solvent having a boiling point of not lower than 120° C. (e.g., about 130 to 300° C.) and preferably not lower than 140° C. (e.g., about 145 to 250° C.), such as dimethylformamide or N-methylpyrrolidone] or conduct heating again for dissolving the dihydroxycarboxylic acid. Accordingly, the manufacturing operation efficiency can be improved.

Incidentally, since the free dihydroxycarboxylic acid is precipitated or separated in the polyester polyol in many cases, the free dihydroxycarboxylic acid may be separated and removed from the carboxyl group-containing polyester polyol by a separation means such as filtration or centrifugation. However, in the case of separating and removing the dihydroxycarboxylic acid, the formulation of the carboxyl group-containing polyester polyol, and others are changed so that an aqueous polyurethane-series resin composition cannot be prepared as planned. Moreover, such a polyester polyol is low in handling properties and lowers producibility of the resin composition. In the present invention, a polyester polyol which is excellent in homogeneity and solubility and has a desired carboxyl group concentration can be obtained without removing the free dihydroxycarboxylic acid by such a separation (or purification).

Incidentally, the polyester polyol of the present invention (or the after-mentioned polyurethane-series resin) may contain, if necessary, various additives such as a stabilizer (for example, an antioxidant, an ultraviolet ray stabilizer, a heat stabilizer, and a light-resistant stabilizer), a coloring agent, an antifoaming agent, a lubricant, a flow control agent, a water repellent agent and a filler. These additives may be used singly or in combination.

### (Process for Producing Polyester Polyol)

The polyester polyol of the present invention may be prepared by allowing a basic compound to exist at an appropriate stage in a polymerization process of a polyester polyol. The polyester polyol may be usually prepared by ring-opening addition polymerizing a cyclic ester (ring-opening polymerize) with a dihydroxycarboxylic acid in the presence of a basic compound. The ring-opening addition polymerization in the presence of the basic compound ensures not only to reduce a free dihydroxycarboxylic acid in the produced polyester polyol by just salt formation but also to certainly add the cyclic ester to the dihydroxycarboxylic acid as an initiator (that is, can improve the initiator efficiency). In such a preparation process, the basic compound may exist in the ring-opening addition polymerization reaction. In particular, the cyclic ester may be ring-opening addition polymerized with a salt of the dihydroxycarboxylic acid with the basic compound. That is, the cyclic ester may be ring-opening addition polymerized with a dihydroxycarboxylic acid as an initiator at least part of which is neutralized with the basic compound beforehand.

Incidentally, the ring-opening addition polymerization of the cyclic ester with the dihydroxycarboxylic acid as an initiator maybe, for example, referred to various documents such as Japanese Patent Application Laid-Open No. 313024/1994 (JP-6-313024A), Japanese Patent Application Laid-Open No. 27243/1996 (JP-8-27243A) and Japanese Patent Application Laid-Open No. 91740/2004 (JP-2004-91740A). Specifically, in the present invention, a ring-opened product of a cyclic ester such as ε-caprolactone (particularly a lactone) is usually allowed to react with a hydroxyl group of a dihydroxycarboxylate salt (e.g., an amine salt) in which at least part of the carboxyl group is neutralized with a basic compound to add the cyclic ester to the dihydroxycarboxylate salt, and further the ring-opened product of the cyclic ester or a polymer thereof is added to a hydroxyl group derived from the cyclic ester in the added product. Furthermore, to an end hydroxyl group thereof is added a ring-opened product of other cyclic ester or a polymer of the product. The ring-opening polymerization of the cyclic ester by the repetition of such additions gives an amine carboxylate group-containing polyester polyol.

In the production of the polyester polyol, the proportion of the cyclic ester may be selected depending on the concentration of the carboxyl group, and others. For example, the proportion of the cyclic ester relative to 1 mol of the dihydroxycarboxylic acid may be, for example, about 1 to 100 mol, preferably about 2 to 80 mol, more preferably about 2.5 to 50 mol and usually about 3 to 30 mol. Incidentally, the proportion of the basic compound is the same as described in the paragraph of the polyester polyol.

Incidentally, the reaction (ring-opening addition polymerization reaction) of the cyclic ester and the dihydroxycarboxylic acid may be carried out in the presence of the basic compound and usually, additionally in the presence of a catalyst (a catalyst for a ring-opening polymerization). The catalyst is not particularly limited to a specific one, and may be suitably selected from known catalysts used for a ring-opening polymerization of a cyclic ester (particularly, a lactone). For example, such a catalyst may include an organic titanium-series compound (for example, a tetraC₁₋₆alkyl titanate such as tetraethyl titanate, tetrapropyl titanate, tetraisopropyl titanate or tetrabutyl titanate), an organic tin-series compound (for example, dibutyltin oxide; a tin fatty acid salt such as dibutyltin dilaurate, stannous octylate, a mono-n-butyltin fatty acid salt (e.g., monobutyltris(2-ethylhexanoate)tin)), a tin halide-series compound (for example, a stannous halide such as stannous chloride, stannous bromide or stannous iodide), and others. These catalysts may be used singly or in combination.

The amount of the catalyst may be, for example, not more than 1000 ppm (e.g., about 0 to 800 ppm), preferably not more than 500 ppm (e.g., about 0.1 to 400 ppm) and more preferably about 10 to 300 ppm on the basis of weight relative to the total amount of the cyclic ester and the dihydroxycarboxylic acid. In the case where the amount of the catalyst is too large, the ring-opening reaction proceeds remarkably rapidly, and there is a possibility that the synthetic resin comprising the obtained amine carboxylate group-containing polyester polyol lowers in physical properties such as durability and water resistance. Incidentally, even in the case of using no catalyst, that is, in the absence of the catalyst, it is possible to carry out the ring-opening polymerization of the cyclic ester.

Moreover, in the ring-opening polymerization of the cyclic ester, the temperature of the ring-opening polymerization (polymerization temperature or reaction temperature) is not particularly limited to a specific one, and may be suitably selected depending on the species of the cyclic ester, and others. The temperature of the ring-opening polymerization may be, for example, suitably selected from the range of about 80 to 240° C. (e.g., about 85 to 200° C.), preferably about 90 to 180° C. and more preferably about 100 to 160° C. In particular, the temperature is preferably about 150° C. (e.g., about 140 to 160° C.), and may be usually about 110 to 220° C. In the case where the polymerization temperature in the ring-opening polymerization of the cyclic ester is too low (e.g., lower than 80° C.), the ring-opening polymerization reaction of the cyclic ester is remarkably slow so that there is a possibility to bring the economical disadvantage. On the other hand, in the case where the polymerization temperature in the ring-opening polymerization of the cyclic ester is too high (e.g., over 240° C.), there is a possibility that gelation occurs due to intermolecular condensation by dehydration.

Incidentally, the ring-opening polymerization of the cyclic ester may be carried out under either an oxygen atmosphere or an inactive atmosphere. In the case of conducting the ring-opening polymerization under an inactive gas such as nitrogen gas, good results are obtained in the hue of the finished product and others in many cases.

The polyester polyol of the present invention may be utilized as a polyol component (for example, a polyol component of a variety of resins), and particularly, may be preferably used as a polyol component of a polyurethane-series resin.

Hereinafter, the polyurethane-series resin will be described in detail.

### [Polyurethane-series Resin]

The polyurethane-series resin (or urethane prepolymer) is a carboxyl group-containing urethane prepolymer having an isocyanate group in an end thereof, and is obtained by allowing a polyol component (a polyol-series compound) comprising the polyester polyol of the present invention (amine carboxylate group-containing polyester polyol) to react with a polyisocyanate component (a polyisocyanate-series compound) (and if necessary, a chain-elongation agent). That is, in the polyurethane-series resin, since the polyol component comprises not a conventional carboxyl group-containing polyester polyol but the above-mentioned amine carboxylate group-containing polyester polyol excellent in solubility, the prepolymerization reaction may be conducted in a homogeneous system without using an organic solvent having a high boiling point for dissolving the dihydroxyalkanoic acid as a solvent in preparing the urethane prepolymer or heating the dihydroxyalkanoic acid again for dissolution. Accordingly, the urethane prepolymer may be easily prepared. Therefore, the prepared polyurethane-series resin is high in homogeneity and good in stability, and is also excellent in dryness or working environment or others in coating.

Incidentally, the polyurethane-series resin (polyurethane-series polymer) may be produced by utilizing a known process. If necessary, the polyurethane-series resin (polyurethane-series polymer) may be chain-elongated.

### (Polyol Component)

The polyol component may comprise at least the above-mentioned carboxyl group-containing polyester polyol, and may further contain other polyol component (a polyol-series compound other than the above-mentioned amine carboxylate group-containing polyester polyol). That is, the polyol-series compound may comprise the carboxyl group-containing polyester polyol alone, or may comprise the carboxyl group-containing polyester polyol and other polyol component.

Other polyol component may be suitably selected from polyol-series compounds known as the polyurethane-series resin materials. A polyol component in which a component having a poor solubility in an organic solvent having a low boiling point (for example, dimethylolalkanoic acid) is hardly or not at all contained as other polyol component may be used in the urethanation process. Such a polyol component may include a polymer polyol (a long-chain polyol), a low molecular weight polyol (a short-chain polyol), and others.

The polymer polyol may include a polyether polyol such as a polyalkylene glycol (for example, a polyC₂₋₄alkylene glycol such as a polyethylene glycol, a polypropylene glycol or a polytetramethylene glycol); a polyester polyol such as a polyester polyol obtained by a condensation reaction of a diol component [for example, an alkanediol (e.g., a C₂₋₁₀alkanediol such as ethylene glycol, propylene glycol, 1,4-butanediol, 1,5-pentanediol, neopentyl glycol, 3-methyl-1,5-pentanediol or 1,6-hexanediol)] with a dicarboxylic acid component (for example, adipic acid, terephthalic acid, and isophthalic acid) or a derivative thereof (for example, a lower alkyl ester such as methyl ester or ethyl ester) (for example, a polyethylene adipate having hydroxyl groups in both ends thereof, a polyethylene·butylene adipate having hydroxyl groups in both ends thereof, a polypropylene adipate having hydroxyl groups in both ends thereof, a polyhexamethylene adipate having hydroxyl groups in both ends thereof, a polyneopentylene adipate having hydroxyl groups in both ends thereof, a poly-3-methyl-1,5-pentylene adipate having hydroxyl groups in both ends thereof, and a polyester polyol using terephthalic acid and if necessary isophthalic acid and/or adipic acid as carboxylic acid component(s) and hexamethylene glycol and/or 3-methyl-1,5-pentanediol as diol component(s) and having hydroxyl groups in both ends thereof), a lactone-series polyester polyol [for example, a polyester polyol obtained by a ring-opening addition polymerization of a lactone (e.g., the lactone exemplified in the paragraph of the above-mentioned carboxyl group-containing polyester polyol) with a short-chain polyol such as a caprolactone-series polyol (e.g., a polycaprolactone having hydroxyl groups in both ends thereof, and a polymethylvalerolactone having hydroxyl groups in both ends thereof) (e.g., the after-mentioned low molecular weight polyol) as an initiator]; and in addition, a polycarbonate polyol; a silicone polyol; a polyolefin polyol (e.g., a polybutadiene polyol); and others.

The number average molecular weight of the polymer polyol is not particularly limited to a specific one, and may be, for example, about 400 to 5000, preferably about 500 to 3000 and more preferably about 600 to 2000.

Moreover, the low molecular weight polyol may include a diol, a triol, a polyol, and others. The diol may include, for example, an alkanediol (e.g., a C₂₋₁₂alkanediol such as ethylene glycol, propylene glycol, 1,3-butanediol, 1,4-butanediol, neopentyl glycol, 3-methyl-1,5-pentanediol, 1,6-hexanediol, 2,2,4- and/or 2,4,4-trimethyl-1,6-hexanediol, 2,2,4-trimethyl-1,5-pentanediol, 1,10-decanediol or 1,12-dodecanediol), a dialkylene glycol (e.g., a diC₂₋₄alkylene glycol such as diethylene glycol or dipropylene glycol), a cycloalkanediol (e.g., 1,4-cyclohexanedimethanol), a bisphenol compound (e.g., bisphenol A), and an alkanolamine (e.g., diethanolamine). As the triol, for example, there may be mentioned glycerin, trimethylolethane, trimethylolpropane, and triethanolamine. The polyol may include a tetraol (e.g., pentaerythritol), and others. Incidentally, these low molecular weight polyols may be used as a chain-extension agent.

These polyol-series compounds may be used singly or in combination.

In the case of using other polyol component, the proportion of other polyol component relative to the total polyol component (that is, the total amount of the above-mentioned carboxyl group-containing polyester polyol and other polyol component) may be, for example, about 5 to 80% by weight, preferably about 10 to 75% by weight and more preferably about 20 to 70% by weight.

### (Polyisocyanate Component)

The polyisocyanate component (polyisocyanate-series compound) is not particularly limited to a specific one, and may be suitably selected from polyisocyanate-series compounds (organic polyisocyanates) known as the polyurethane-series resin materials. Concretely, the polyisocyanate-series compound may include, for example, an aromatic diisocyanate-series compound such as 4,4′-diphenylmethane diisocyanate, 2,4-tolylene diisocyanate, 2,6-tolylene diisocyanate, 1,5-naphthalene diisocyanate, p-phenylene diisocyanate, m-phenylene diisocyanate, 3,5-diethyl-2,4-diisocyanatotoluene or 1,3-bis(isocyanatophenyl)propane; an alicyclic diisocyanate-series compound such as isophorone diisocyanate, 4,4′-dicyclohexylmethane diisocyanate, 1,4-cyclohexylene diisocyanate, norbornene diisocyanate, a hydrogenated product of a tolylene diisocyanate, a hydrogenated product of a xylylene diisocyanate, or a hydrogenated product of a bis(isocyanatophenyl)methane; an aliphatic diisocyanate-series compound such as hexamethylene diisocyanate, trimethylhexamethylene diisocyanate or lysine diisocyanate; and an araliphatic diisocyanate-series compound such as xylylene diisocyanate or m-tetramethylxylylene diisocyanate. The polyisocyanate-series compounds may be used singly or in combination.

As the polyisocyanate-series compound, an alicyclic diisocyanate-series compound (particularly, isophorone diisocyanate) may be preferably used from the viewpoints of easiness of production, high stability of the polyurethane-series resin in water, no yellowing, and others.

The proportion of the polyol component relative to the polyisocyanate component on the basis of equivalent ratio of the isocyanate group (NCO) of the polyisocyanate component relative to the hydroxyl group (OH) of the polyol component [the isocyanate group/the hydroxyl group] may be, for example, about 1/1 to 6/1, preferably about 1.05/1 to 5/1 and more preferably about 1.1/1 to 4/1 (particularly about 1.1/1 to 3/1).

### (Chain-extension Agent)

The polyurethane-series resin may be chain-extended (or chain-elongated) with a chain-extension agent (or chain-elongation agent). The chain-extension agent may be suitably selected from known chain-elongation agents (e.g., an amine-series chain-elongation agent, and a diol-series chain-elongation agent). The amine-series chain-elongation agent may be preferably used as the chain-extension agent.

The amine-series chain-elongation agent may include an aliphatic diamine (e.g., a C₂₋₈alkanediamine such as ethylenediamine, propylenediamine, tetra methylenediamine, N,N-dimethylethylenediamine or hexamethylenediamine), an alicyclic diamine (e.g., 1,4-cyclohexylenediamine, 3-aminomethyl-3,5,5-trimethylcyclohexylamine, isophoronediamine, 4,4′-dicyclohexylmethanediamine, 1,3-bis(aminomethyl)cyclohexane, and norbornanediamine), an aromatic diamine (e.g., phenylenediamine), an araliphatic diamine (e.g., m-xylylenediamine), an aliphatic polyamine (e.g., a polyethylenepolyamine such as diethylenetriamine, triethylenetetramine or tetraethylenepentamine), a piperazine compound (e.g., 1,3-piperazine, 1,4-piperazine, 2-methyl-1,4-piperazine, and 2,5-dimethyl-1,4-piperazine), a hydrazine or dihydrazide compound (e.g., hydrazine, and a dihydrazide compound of hydrazine with adipic acid or phthalic acid), an alkanolamine (e.g., monoethanolamine), and others. Incidentally, the diol-series chain-elongation agent may include the above-mentioned low molecular weight polyol component, and others. The chain-elongation agents may be used singly or in combination.

Incidentally, in the case of intending to introduce a hydroxyl group to the end of the main chain of the polyurethane-series resin, a hydroxyamine such as an alkanolamine (e. g., monoethanolamine, and diethanolamine) may be used together with the chain-elongation agent such as an amine-series chain-elongation agent. Moreover, in the case of intending to introduce a hydroxyl group to the main chain of the polyurethane-series resin, a polyamine having a hydroxyl group (e.g., aminoethylaminoethanol) and others may be used together with the chain-elongation agent such as an amine-series chain-elongation agent.

The amount of the chain-extension agent is not particularly limited to a specific one. The proportion of the isocyanate group (NCO) in the urethane prepolymer relative to the active hydrogen atom (H) in the chain-extension agent [the former/the latter (equivalent ratio)] may be about 5/1 to 1/5, preferably about 3/1 to 1/3 and more preferably about 2/1 to 1/2 (e.g., about 1.5/1 to 1/1.5).

Moreover, the end of the polyurethane-series resin may be capped or blocked with an end-capping agent. The end-capping agent may include a monofunctional active hydrogen-containing compound, for example, a C₁₋₂₄monoalcohol such as methanol, ethanol, isopropanol, propanol, butanol, hexanol, lauryl alcohol or cetyl alcohol, or an alkylene oxide adduct thereof (e.g., a C₂₋₄alkylene oxide adduct such as ethylene oxide adduct), an oxime such as methyl ethyl ketoxime, a lactam such as ε-caprolactam, a monoamine such as dibutylamine, and others. These end-capping agents may be used singly or in combination.

The proportion of the carboxyl group in the polyurethane-series resin is not particularly limited to a specific one. The proportion of the carboxyl group may be, for example, about 0.4 to 5% by weight, preferably about 0.6 to 4.5% by weight and more preferably about 0.8 to 4.2% by weight relative to the total solid content of the polyurethane-series resin. In the case where the proportion of the carboxyl group in the polyurethane-series resin is too small (for example, the proportion is less than 0.4% by weight relative to the total solid content of the polyurethane-series resin), it is difficult to make the resin aqueous. On the other hand, in the case where the proportion is too large (for example, the proportion is over 5% by weight), there is a possibility of lowering the coat properties of the resin, and others. Incidentally, the proportion of the carboxyl group in the polyurethane-series resin may be adjusted, for example, by regulating the content of the carboxyl group-containing polyester polyol in the polyol-series compound depending on the species of the carboxyl group-containing polyester polyol.

The number average molecular weight of the polyurethane-series resin is not particularly limited to a specific one, and may be, for example, about 6000 to 500000 (preferably about 7000 to 300000, and more preferably about 8000 to 150000). The number average molecular weight of the polyurethane-series resin may be determined, for example, in terms of polystyrene, by a gel permeation chromatography (GPC) measurement.

The polyurethane resin may further contain, if necessary, a conventional additive, for example, other stabilizer (e.g., an antioxidant, an ultraviolet ray absorber, a heat stabilizer, and a light-resistant stabilizer), a coloring agent (e.g., a dye, and a pigment), a filler, a lubricant, a crosslinking or curing agent, an antistatic agent, an antiblocking agent, and others. These additives may be used singly or in combination.

As described above, the polyurethane-series resin is obtained by allowing the polyol component to react with the polyisocyanate component (and if necessary the chain-elongation agent) (urethanation reaction). The reaction may be carried out in the absence of a solvent, or may be carried out in a solvent to facilitate a subsequent operation for emulsifying and dispersing the polyurethane-series resin by adding water thereto to give an oil-in-water type product. The use of the solvent ensures the reaction under a reduced viscosity of the reaction system (or the urethane prepolymer). The solvent used for preparing the polyurethane resin (urethane prepolymer) preferably includes an organic solvent having a relatively low boiling point (e.g., a solvent having a boiling point of not higher than 100° C.) in the light of removing the solvent afterward. Such a solvent may include, for example, a ketone (e.g., acetone, and methyl ethyl ketone), an ether (e.g., dioxolan, and tetrahydrofuran), and an ester (e.g., methyl acetate, and ethyl acetate). These solvents may be used singly or in combination. The preferred solvent includes acetone, methyl ethyl ketone, and others. In particular, acetone is preferred.

The urethanation for preparing the urethane prepolymer may be conducted under an inactive gas flow such as a nitrogen flow, and is usually conducted under a nitrogen flow. Moreover, the urethanation is usually carried out in the absence of a catalyst, and may be carried out in the presence of a catalyst. The catalyst used for the urethanation is not particularly limited to a specific one, and may include, for example, an organic metal catalyst such as an organic tin-series compound (e.g., dibutyltin dilaurate, dibutyltin dioctanoate, and dibutyltin diacetate); and a tertiary amine-series catalyst such as triethylenediamine. The catalysts may be used singly or in combination.

Moreover, the reaction temperature in the urethanation may be about 20 to 180° C, preferably about 30 to 160° C., more preferably about 40 to 140° C., and usually about 20 to 120° C. It is important to suitably select the reaction time in the urethanation depending on the temperature of the reaction in each step, and others. Although the reaction time cannot be altogether defined, the reaction time may be usually about 1 to 20 hours.

Incidentally, as described above, in the case of using the solvent in the urethanation, it is necessary to remove the solvent. The method for removing the solvent is not particularly limited to a specific one. In the case where the solvent is the organic solvent having a low boiling point, the method may include, for example, (i) a method of removing the organic solvent having a low boiling point by feeding an inactive gas such as air or nitrogen gas to the surface of a liquid reaction product or in the liquid reaction product at a temperature of not higher than the boiling point of water (e.g., at about 30 to 100° C.), (ii) a method of removing the organic solvent having a low boiling point by decreasing the internal pressure of a reaction vessel, and (iii) a method of using a thin-film evaporator.

Incidentally, little or no solvent preferably remains in the polyurethane-series resin. In an application in which a small amount of the organic solvent is acceptable, the organic solvent may be used in producing the polyurethane-series resin and be allowed to remain in the reaction product as it is.

Incidentally, the chain-elongation may be carried out at an appropriate stage in the urethane prepolymer preparation. For example, the polyol component, the polyisocyanate and the chain-elongation agent may be allowed to react together; the polyol component may be allowed to react with the polyisocyanate component, and then the chain-elongation agent may be allowed to react with the reaction product; or as described later, the reaction product in the form of a water dispersion or aqueous solution may be allowed to react with the chain-elongation agent.

The polyurethane-series resin may be in the form of an aqueous emulsion (water dispersion) or aqueous solution as usage due to a high hydrophilicity. In the polyurethane-series resin in the form of such an aqueous emulsion or aqueous solution (sometimes referred to as an aqueous resin composition, an aqueous polyurethane-series resin, an aqueous polyurethane-series resin composition, or the like), the polyurethane-series resin is usually dispersed or dissolved in water in many cases. In the case where the polyurethane-series resin is dispersed in water (an emulsion), the average particle size of the polyurethane-series resin dispersed in water is not particularly limited to a specific one, and for example, may be not larger than 50 μm (e.g., about 0.001 to 50 μm), preferably about 0.01 to 20 μm and more preferably about 0.01 to 5 μm. Incidentally, the exterior appearance of the aqueous polyurethane-series resin composition varies depending on the size of the dispersed particle (that is, the particle of the polyurethane-series resin dispersed in water). In the case where the average particle size of the dispersed particle is small, the aqueous polyurethane-series resin composition is in a solution-like form generating fluorescence in many cases. In the case where the average particle size thereof is large, the aqueous polyurethane-series resin composition is in a pure white emulsion form in many cases. Incidentally, in either case, the aqueous polyurethane-series resin composition can retain the stability over time.

In the aqueous polyurethane-series resin composition (the polyurethane-series resin in the form of a water dispersion or aqueous solution), the concentration of the solid content (or polyurethane-series resin) may be usually about 10 to 70% by weight, preferably about 20 to 65% by weight and more preferably about 30 to 60% by weight. The viscosity of the aqueous emulsion (25° C.) may be, for example, about 10 to 500 mPa·s, preferably about 30 to 400 mPa·s and more preferably 50 to 300 mPa·s (particularly about 100 to 250 mPa·s) from the viewpoint of coating properties and others. The solid content concentration or viscosity of the aqueous polyurethane-series resin composition can be adjusted by controlling the size of the dispersed particle of the polyurethane-series resin as usage. Incidentally, there is a tendency as follows: the average particle size of the dispersed particle becomes larger in the case where the amount of the hydrophilic group (e.g., carboxyl group) in the polyurethane-series resin is reduced, and on the other hand, the average particle size thereof becomes smaller in the case where the amount of the hydrophilic group (e.g., carboxyl group) in the polyurethane-series resin is increased.

The aqueous polyurethane-series resin composition may be produced, for example, by dispersing or dissolving the above-mentioned polyurethane-series resin (urethane prepolymer) in water, and if necessary chain-elongating the resin (polymer) with a chain-elongation agent (e.g., the chain-elongation agent as exemplified above). Incidentally, in the preparation of the aqueous polyurethane-series resin, the urethane prepolymer may be diluted with a solvent (e.g., the organic solvent having a low boiling point as exemplified above) beforehand.

Incidentally, the aqueous emulsion or aqueous solution may contain the additive exemplified in the paragraph of the above-mentioned polyurethane-series resin, and additionally, a dispersing agent (a surfactant), an emulsion stabilizer, a flow control agent, a water repellent agent, an antifoaming agent, a coatability-improving agent, a thickening agent, a gelatinizing agent, and others. These additives may be used singly or in combination.

In the polyester polyol (carboxyl group-containing polyester polyol) of the present invention, since at least part of carboxyl group of a dihydroxycarboxylic acid as an initiator is neutralized with a basic compound, the content of a free (or unreacted) dihydroxycarboxylic acid is low even in the case of using the dihydroxycarboxylic acid as an initiator. Accordingly, the polyester polyol of the present invention generates no phase separation or others due to a free dihydroxycarboxylic acid even in the case of using the dihydroxycarboxylic acid as an initiator, and is excellent in homogeneity and solubility.

Moreover, since the polyester polyol of the present invention has a reduced content of the free dihydroxycarboxylic acid and is excellent in homogeneity as described above, it is unnecessary to remove the dihydroxycarboxylic acid from the polyester polyol by a method such as filtration, and the concentration of the carboxyl group in the polyester polyol can be adjusted efficiently in the preparation stage. Therefore, according to the present invention, the content of the free dihydroxycarboxylic acid is reduced and the concentration of the carboxyl group in the polyester polyol can be adjusted to a desired concentration. Accordingly, the polyester polyol is excellent in handling properties.

Further, the polyester polyol of the present invention is homogeneous even in the case of using a dihydroxycarboxylic acid as an initiator. Accordingly, in the use of the polyester polyol as a polyol component of a polyurethane-series resin or others, it is unnecessary to add a solvent having a high boiling point to the polyester polyol or to heat the polyester polyol at a high temperature for dissolving a free dihydroxycarboxylic acid. Therefore, the polyester polyol of the present invention is excellent in homogeneity and stability, and can be improved in dryness or working environment in coating. Moreover, the polyester polyol of the present invention can be subjected to a urethanation with a polyisocyanate in a homogeneous system advantageously from industrial point of view without adding a solvent having a high boiling point or heating again.

Furthermore, according to the present invention, since the initiator efficiency of a dihydroxycarboxylic acid can be improved by ring-opening addition polymerizing a cyclic ester with a dihydroxycarboxylic acid in the presence of a basic compound, the content of a free dihydroxycarboxylic acid in the produced polyester polyol can be efficiently reduced.

The polyester polyol of the present invention has a remarkably reduced content of a free dihydroxycarboxylic acid and is excellent in homogeneity and stability. Further, the polyester polyol is excellent in working environment in handling and coating, or dryness in coating. Therefore, the polyester polyol of the present invention can be preferably used as a polyol component of various polymers, in particular, a polyol component of a polyurethane-series resin (an aqueous polyurethane-series resin) (specifically, a polyol component which is subjected to a urethanation reaction with a polyisocyanate component). Moreover, the polyurethane-series resin is useful for a wide range of application such as a paint, a binder for a print ink or others, and an adhesive.

Incidentally, the polyurethane-series resin is suitable for application such as various paints, binders and adhesives. The polyurethane-series resin may be used as a one-component type as it is. If necessary, the polyurethane-series resin may be mixed with an aqueous block-type isocyanate curing agent, a water-dispersion-type isocyanate curing agent which does not block an isocyanate group, a melamine-series curing agent, a polyaziridine compound, and others, as a crosslinking agent, to be used as a two-component type.

### EXAMPLES

Hereinafter, the following examples are intended to describe this invention in further detail and should by no means be interpreted as defining the scope of the invention. Incidentally, unless otherwise noted, “part(s)” and “%” indicate “part(s) by weight” and “% by weight”, respectively, in the examples. Moreover, in the examples, each property or physical property was measured as follows.

### (Content of Dimethylolalkanoic Acid)

The content of a dimethylolalkane was determined from an area (%) of a chromatograph by means of a gel permeation chromatography (GPC).

### (Number Average Molecular Weight)

The number average molecular weight was measured by a gel permeation chromatography (GPC) under the following measurement conditions.

Apparatus: Apparatus name “HPLC LC-6A SYSTEM” (manufactured by Shimadzu Corporation)

Column: “KF-800P (10 mm×4.6 mmφ)”, “KF-804 (300 mm×8 mmφ)”, “KF-802.5 (300 mm×8 mmφ)”, “KF-801 (300 mm×8 mmφ)” (those are manufactured by Showa Denko K.K. (trade name “SHODEX”))

Mobile phase: Tetrahydrofuran (THF)

Flow rate: 1.0 ml/min

Sample amount: 100 μl (100-fold dilution)

Column temperature: 50° C.

Standard substance for making working curve: Polystyrene (PSt)

### (Mechanical Properties)

A film was cut into 10×120 mm with a punching blade, and the tensile strength (MPa) and the elongation (%) were measured at an elastic stress rate of 500 mm/minute, a temperature of 23° C. and a humidity of 60% RH by using “TENSILON UTM-III-100” (manufactured by Toyo Boldwin Co., Ltd.) in accordance with JIS K6301.

### (Viscosity)

The viscosity at 25° C. (mPa·s/25° C.) was measured by using an EM-type rotation viscometer (manufactured by Toki Sangyo Co., Ltd.). Incidentally, the viscosity was determined under a measurement condition of a rotational frequency of 5 rpm.

### (Average Particle Size)

The average particle size was measured by using a measuring apparatus for a particle size distribution (manufactured by Horiba, Ltd.).

### Example 1

To a reactor, 134 parts of dimethylolpropionic acid (2,2-di(hydroxymethyl)propionic acid), 101 parts of triethylamine and 465.5 parts of ε-caprolactone were fed. To the mixture were added 50 ppm of stannous octylate as a catalyst, and heated with stirring under a nitrogen flow to dissolve each component homogeneously. Then, the mixture was subjected to a reaction at 120° C. for 6 hours. After confirming that the ε-caprolactone content was reduced to not more than 1%, the temperature of the reaction system was reduced. The obtained amine carboxylate group-containing polyester polyol was in the form of a liquid at a room temperature, and had a dimethylolpropionic acid content of 2.0% and a number average molecular weight of 700.

### Example 2

To a reactor, 134 parts of dimethylolpropionic acid, 101 parts of triethylamine and 366 parts of ε-caprolactone were fed. To the mixture were added 100 ppm of stannous chloride as a catalyst, and heated with stirring under a nitrogen flow to dissolve each component homogeneously. Then, the mixture was subjected to a reaction at 130° C. for 4 hours. After confirming that the ε-caprolactone content was reduced to not more than 1%, the temperature of the reaction system was reduced. The obtained amine carboxylate group-containing polyester polyol was in the form of a liquid at a room temperature, and had a dimethylolpropionic acid content of 2.3% and a number average molecular weight of 600.

### Example 3

To a reactor, 148 parts of dimethylolbutanoic acid (2,2-di(hydroxymethyl)butanoic acid), 101 parts of triethylamine and 452 parts of ε-caprolactone were fed. To the mixture were added 100 ppm of stannous octylate as a catalyst, and heated with stirring under a nitrogen flow to dissolve each component homogeneously. Then, the mixture was subjected to a reaction at 150° C. for 4 hours. After confirming that the ε-caprolactone content was reduced to not more than 1%, the temperature of the reaction system was reduced. The obtained amine carboxylate group-containing polyester polyol was in the form of a liquid at a room temperature, and had a dimethylolbutanoic acid content of 1.9% and a number average molecular weight of 700.

### Example 4

To a reactor, 134 parts of dimethylolpropionic acid, 101 parts of triethylamine and 216 parts of ε-caprolactone were fed. To the mixture were added 100 ppm of stannous octylate as a catalyst, and heated with stirring under a nitrogen flow to dissolve each component homogeneously. Then, the mixture was subjected to a reaction at 150° C. for 4 hours. After confirming that the ε-caprolactone content was reduced to not more than 1%, the temperature of the reaction system was reduced. The obtained amine carboxylate group-containing polyester polyol was in the form of a liquid at a room temperature, and had a dimethylolpropionic acid content of 2.2% and a number average molecular weight of 450.

### Example 5

To a reactor, 134 parts of dimethylolpropionic acid, 101 parts of triethylamine and 866 parts of ε-caprolactone were fed. To the mixture were added 100 ppm of monobutyltintris(2-ethylhexanoate) as a catalyst, and heated with stirring under a nitrogen flow to dissolve each component homogeneously. Then, the mixture was subjected to a reaction at 150° C. for 4 hours. After confirming that the ε-caprolactone content was reduced to not more than 1%, the temperature of the reaction system was reduced. The obtained amine carboxylate group-containing polyester polyol was in the form of a liquid at a room temperature, and had a dimethylolpropionic acid content of 1.8% and a number average molecular weight of 1100.

### Comparative Example 1

To a reactor, 134 parts of dimethylolpropionic acid and 366 parts of ε-caprolactone were fed. To the mixture were added 100 ppm of stannous octylate as a catalyst, and heated with stirring under a nitrogen flow to dissolve each component homogeneously. Then, the mixture was subjected to a reaction at 150° C. for 4 hours. After confirming that the ε-caprolactone content was reduced to not more than 1%, the temperature of the reaction system was reduced. The obtained amine carboxylate group-containing polyester polyol had a dimethylolpropionic acid content of 20% and a number average molecular weight of 500. When the amine carboxylate group-containing polyester polyol was allowed to stand at a room temperature, dimethylolpropionic acid was precipitated as crystals. Once precipitated dimethylolpropionic acid was not dissolved even when the temperature of the system was raised up to 100° C., and the system was cloudy.

### Comparative Example 2

To a reactor, 134 parts of 2,2-dimethylolpropionic acid and 866 parts of ε-caprolactone were fed. To the mixture were 100 ppm of stannous octylate as a catalyst, and heated with stirring under a nitrogen flow to dissolve each component homogeneously. Then, the mixture was subjected to a reaction at 150° C. for 4 hours. After confirming that the ε-caprolactone content was reduced to not more than 1%, the temperature of the reaction system was reduced. The obtained amine carboxylate group-containing polyester polyol had a dimethylolpropionic acid content of 10% and a number average molecular weight of 1000. When the amine carboxylate group-containing polyester polyol was allowed to stand at a room temperature, dimethylolpropionic acid was precipitated as crystals. Once precipitated dimethylolpropionic acid was not dissolved even when the temperature of the system was raised up to 100° C., and the system was cloudy.

The results are shown in Table 1.

TABLE 1

| | Proportion (mol) of | Number | |
|---|---|---|---|
| | amine relative to 1 mol | average | Dimethylolalkanoic |
| | of dimethylolalkanoic | molecular | acid contained in |
| | acid | weight | Polyester polyol (%) |
| Example 1 | 1.0 | 700 | 2.0 |
| Example 2 | 1.0 | 600 | 2.3 |
| Example 3 | 1.0 | 700 | 1.9 |
| Example 4 | 1.0 | 450 | 2.2 |
| Example 5 | 1.0 | 1100 | 1.8 |
| Comparative | — | 500 | 20 |
| Example 1 | | | |
| Comparative | — | 1000 | 10 |
| Example 2 | | | |

### Example 6

To a reactor, 83.5 parts of isophorone diisocyanate, 111.6 parts of a polytetramethylene ether glycol having a number average molecular weight of 1000 (manufactured by Mitsubishi Chemical Corporation, trade name “PTMG1000”) and 64.2 parts of a polyester polyol in a liquid form at a room temperature obtained in Example 3 (number average molecular weight: 700) were fed. The mixture was subjected to a reaction with stirring under a nitrogen flow at 80° C. for 5 hours to give a homogeneous and transparent urethane prepolymer having an end NCO group. To the urethane prepolymer were gradually added 383.4 parts of demineralized water to give an oil-in-water type urethane prepolymer dispersion. Then, to the dispersion were added 33.22 parts of isophoronediamine and 299.0 parts of demineralized water at 10° C. to chain-elongate the prepolymer, and an aqueous polyurethane resin was obtained. The obtained polyurethane resin had a solid content of 30%, a viscosity of 230 mPa·s (25° C.) and an average particle size of 1 μm.

The obtained polyurethane-series resin was coated on a glass plate at intervals of 250 μm, and dried at 80° C. for 2 hours to give a homogeneous, transparent and soft film having a thickness of about 70 μm. After the obtained film was allowed to stand under an atmosphere of 23° C. and 60% RH for one day, the tensile test of the film under the same environment was conducted. As the results of the test, the film had a tensile strength of 55 MPa and an elongation of 700% and showed good physical properties. Further, the obtained film was dissolved in tetrahydrofuran at a concentration of 1%, and the molecular weight of the polyurethane-series resin was measured by a GPC (gel permeation chromatography). As the result, the number average molecular weight thereof was 31000 in terms of polystyrene.

### Example 7

To a reactor, 80.6 parts of isophorone diisocyanate, 107.6 parts of a polytetramethylene ether glycol having a number average molecular weight of 1000 (manufactured by Mitsubishi Chemical Corporation, trade name “PTMG1000”) and 74.3 parts of a polyester polyol in a liquid form at a room temperature obtained in Example 2 (number average molecular weight: 600) were fed. The mixture was subjected to a reaction with stirring under a nitrogen flow at 80° C. for 5 hours to give a homogeneous and transparent urethane prepolymer having an end NCO group. To the urethane prepolymer were gradually added 382.6 parts of demineralized water to give an oil-in-water type urethane prepolymer dispersion. Then, to the dispersion were added 33.22 parts of isophoronediamine and 299.0 parts of demineralized water at 10° C. to chain-elongate the prepolymer, and an aqueous polyurethane resin having a solid content of 30%, a viscosity of 180 mPa·s (25° C.) and an average particle size of 2 μm was obtained. In the same manner as Example 6, a homogenous and transparent film was obtained, and the tensile test was conducted under the same condition. The film had a tensile strength of 45 MPa and an elongation of 645% and showed good physical properties. Moreover, in the same manner as Example 6, the number average molecular weight of the obtained polyurethane resin was measured. As the result, the number average molecular weight thereof was 39000.

### Comparative Example 3

To a reactor, 86.7 parts of isophorone diisocyanate, 115.8 parts of a polytetramethylene ether glycol having a number average molecular weight of 1000 (manufactured by Mitsubishi Chemical Corporation, trade name “PTMG1000”) and 47.5 parts of a polyester polyol obtained in Comparative Example 1 (number average molecular weight: 500) were fed. The system was heterogeneous due to the remaining dimethylolpropionic acid. Incidentally, the polyester polyol obtained in Comparative Example 1 could not retain the liquid form even by pre-heating in an oven at 80° C. for a night and day. Therefore, to the reactor, 86.7 parts of isophorone diisocyanate, 115.8 parts of a polytetramethylene ether glycol having a number average molecular weight of 1000 (manufactured by Mitsubishi Chemical Corporation, trade name “PTMG1000”), 47.5 parts of a polyester polyol obtained in Comparative Example 1 (number average molecular weight: 500), and 2.5 parts of N-methylpyrrolidone for dissolving the remaining dimethylolpropionic acid were added. The mixture was subjected to a reaction with stirring under a nitrogen flow at 80° C. for 5 hours to give a homogeneous and transparent urethane prepolymer having an end NCO group.

Then, the reactor was adjusted to a temperature of 50° C., and 9.59 parts of triethylamine was added thereto for neutralization of the urethane prepolymer. To the mixture were gradually added 384.2 parts of demineralized water to give an oil-in-water type urethane prepolymer dispersion. Then, to the dispersion were added 33.22 parts of isophoronediamine and 299.0 parts of demineralized water at 10° C. to chain-elongate the prepolymer, and an aqueous polyurethane resin was obtained. The obtained polyurethane resin had a solid content of 30%, a viscosity of 180 mPa·s (25° C.) and an average particle size of 5 μm, and contained N-methylpyrrolidone in a proportion of 3.5% by weight. Then, in the same manner as Example 6 except for drying the resin at 80° C. for 4 hours, a homogeneous and transparent film was obtained. The tensile test under the same condition was conducted and the films had a tensile strength of 52 MPa and an elongation of 580% and showed good physical properties. Moreover, in the same manner as Example 6, the number average molecular weight of the obtained polyurethane resin was measured. As the result, the number average molecular weight thereof was 43000.

What is claimed is:

1. A polyester polyol in which a cyclic ester is ring-opening addition polymerized with a dihydroxycarboxylic acid as an initiator, wherein at least part of a carboxyl group of the polyester polyol forms a carboxylate with a basic compound.

2. A polyester polyol according to claim 1, wherein the dihydroxycarboxylic acid comprises a dihydroxyalkanoic acid.

3. A polyester polyol according to claim 1, wherein the dihydroxycarboxylic acid comprises a dimethylolalkanoic acid.

4. A polyester polyol according to claim 1, wherein the cyclic ester comprises a lactone.

5. A polyester polyol according to claim 1, wherein the cyclic ester comprises a caprolactone.

6. A polyester polyol according to claim 1, wherein the basic compound comprises an amine.

7. A polyester polyol according to claim 1, wherein the basic compound comprises a tertiary amine.

8. A polyester polyol according to claim 1, which has a number average molecular weight of 250 to 10000.

9. A polyester polyol according to claim 1, wherein the dihydroxycarboxylic acid in a free form is present in a proportion of not more than 5% by weight relative to the total polyester polyol.

10. A polyester polyol according to claim 1, wherein (i) the dihydroxycarboxylic acid comprises a 2,2-dimethylol-C₃₋₆monoalkanecarboxylic acid, (ii) the cyclic ester comprises a C₄₋₁₀lactone, (iii) the basic compound comprises at least one member selected from the group consisting of a tertiary alkylamine, a tertiary cycloalkylamine and a tertiary alkanolamine, (iv) the number average molecular weight of the polyester polyol is 300 to 5000, and (v) the dihydroxycarboxylic acid in a free form is present in a proportion of not more than 3% by weight relative to the total polyester polyol.

11. A polyester polyol according to claim 1, which constitutes a polyol component of a polyurethane-series resin.

12. A process for producing a polyester polyol recited in claim 1, which comprises ring-opening addition polymerizing a cyclic ester with a dihydroxycarboxylic acid in the presence of a basic compound.

13. A process according to claim 12, which comprises ring-opening addition polymerizing the cyclic ester with a salt of the dihydroxycarboxylic acid with the basic compound.

14. A polyurethane-series resin comprising at least the following components:
a polyol component comprising a polyester polyol recited in claim 1 and
a polyisocyanate component.
